(19) United States
(12) Patent Application Publication
(10) Pub. No.: US 2005/0041195 A1
(43) Pub. Date: Feb. 24, 2005

(54) Method and apparatus to correct lateral color shift in multi-panel projection systems

(76) Inventor: Matthew F. Bone, Fremont, CA (US)

Correspondence Address: HENNEMAN & SAUNDERS, 714 WEST MICHIGAN AVENUE, THREE RIVERS, MI, 49093, US

(21) Appl. No.: 10/645,825

(22) Filed: Aug. 21, 2003

(51) Int. Cl. C09K 19/02

(52) U.S. Cl. 349/179

(57) ABSTRACT

A three panel LC projection apparatus 10 having a plurality of LC panels 20 wherein one of the LC panels 20 has a projected image 16 reversed in relation to the remainder of the LC panels 20. In one of either a red panel 20a, a green panel 20b or a blue panel 20c either a glass buff layer direction 64a or a silicon buff layer direction 64b, 64c is rotatated in a direction opposite to that of the remainder of the LC panels 20. A twist direction of the liquid crystal 44 in that one of the LC panels 20 is correspondingly altered.

### BACKGROUND OF THE INVENTION

1. Field of the Invention

This invention relates generally to the field of video display apparatus and more particularly to an improvement in the construction of liquid crystal (“LC”) projection display apparatus. A predominant current usage of the present inventive color shift correction apparatus and method is for correcting adverse effects found in three panel color projection systems wherein the projected image from one panel is generally reversed in relation to that of the other panels. Theses problems are particularly prominent in a non-telecentric projection system.

2. Description of the Background Art

In many video color projection systems, three LC panels are used, one for each of the three primary colors. The optical system used to combine the images from each of the three LC panels will generally cause the image from one of the panels to be projected as a mirror image as compared to the image from the other two panels. For example, because the three images are combined using mirrors, or the like, two of the images might be reversed by the mirrors while the third image is projected directly into a lens.

The fact that the one projected image, itself, would otherwise be reversed in relation to the other two can be easily corrected, in general, in the electronic driver circuitry, by reversing the electronic image fed to that one LC panel. This will cause all three images to be projected in the same orientation. However, there are also systematic errors introduced by this arrangement which are not so easily corrected. This will be particularly true of systems that are not telecentric. In a non-telecentric system the viewing angle dependence of the LC can have a significant impact on the uniformity of the projected image. For example if there is a systematic left right dependency in the device, and at least one channel is flipped, there will be a “Purple/Green Shift”. While this error may be small, it can be objectionable.

It would be desirable to have a method or apparatus which would cause the three color images to be combined in such a way that the symmetry of all three match. However, to the inventor's knowledge, no such solution to the problem has existed in the prior art.

### SUMMARY

The present invention overcomes at least some of the problems discussed above in relation to the prior art. An object of the present invention is to eliminate or reduce some of the adverse effects caused by viewing angle dependency when the image from one LC panel is reversed in relation to the other two in a three panel LC projection display apparatus.

According to the present invention, one of the LC panels is constructed with a buff direction and twist sense that is the reverse of that of the other two LC panels. While this does not make the resultant product a mirror image of the other two panels in every respect, the inventor has found that the combination of two prior art panels with the one panel constructed in accordance with this invention, will provide a significant improvement as compared to a similar system using three essentially identical panels.

These and other objects and advantages of the present invention will become clear to those skilled in the art in view of the description of modes of carrying out the invention, and the industrial applicability thereof, as described herein and as illustrated in the several figures of the drawing. The objects and/or advantages discussed herein are not intended to be an exhaustive listing of all possible objects or advantages of the invention. Moreover, it will be possible to practice the invention even where one or more of the intended objects and/or advantages might be absent or not required in the application.

Further, those skilled in the art will recognize that various embodiments of the present invention may achieve one or more, but not necessarily all, of the potential objects and/or advantages of the invention. Accordingly, any objects and/or advantages which are discussed herein are not essential elements of the present invention, and should not be construed as limitations.

### BRIEF DESCRIPTION OF THE DRAWINGS

FIG. 1 is a diagrammatic top plan view of a color LC projection apparatus, according to the present invention;

FIG. 2 is a diagrammatic view of one of the LC panels of the LC projection apparatus;

FIG. 3 is an exploded diagrammatic view of a combined image produced by the LC projection apparatus;

FIG. 4 is a partial cross sectional side elevational view of an LC panel as used in the present invention;

FIG. 5 is diagrammatic representation of a buffing apparatus such as might be used to construct an example of the present inventive apparatus;

FIG. 6 is a diagrammatic representation depicting relative buff directions in a LC projection apparatus according to the present invention;

FIG. 7 is a diagrammatic representation depicting relative buff directions in an example of the green panel of the example of the present invention; and

FIG. 8 is a flow diagram depicting some operations of an example of the present inventive method.

### DETAILED DESCRIPTION

This invention is described in the following description with reference to the Figures, in which like numbers represent the same or similar elements. While this invention is described in terms of modes for achieving this invention's objectives, it will be appreciated by those skilled in the art that variations may be accomplished in view of these teachings without deviating from the spirit or scope of the present invention.

The embodiments and variations of the invention described herein, and/or shown in the drawings, are presented by way of example only and are not limiting as to the scope of the invention. Unless otherwise specifically stated, individual aspects and components of the invention may be omitted or modified, or may have substituted therefore known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations.

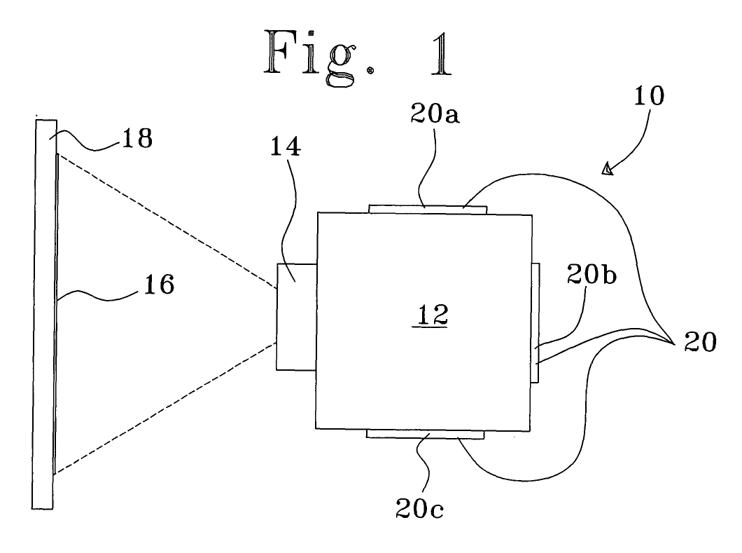

FIG. 1 is a diagrammatic top plan view of a three panel LC projection apparatus 10 according to one embodiment of the invention. It should be noted that the diagrammatic view of FIG. 1 is neither to scale nor in correct proportion. Rather, the proportion of components is altered so that the relationship can best be illustrated. One skilled in the art will be readily familiar with the type of components to be discussed in relation to FIG. 1.

As can be seen in the view of FIG. 1, the three panel LC projection apparatus 10 has a projector housing 12 with a lens assembly 14 for projecting a combined image 16 onto a projection screen 18. Three LC panels 20 are positioned about the projector housing 12. In this present example, the three LC panels 20 are a red panel 20a, a green panel 20b, and a blue panel 20c. Within the projector housing 12 are optics (not shown) for combining images from the three LC panels 20. These optics can be essentially any system, presently known or yet to be invented, for combining images. The exact nature of the optics within the projector housing 12 are not relevant to the present invention, except that they cause the images from one of the LC panels 20 to be reversed in some sense (either left to right, or top to bottom) in relation to the other two LC panels 20.

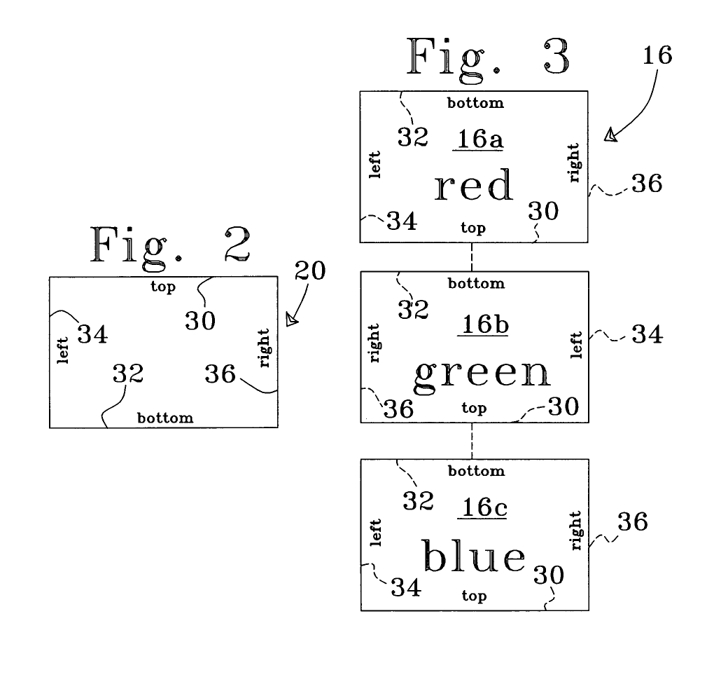

FIG. 2 is a diagrammatic view of one of the LC panels 20. The diagram of FIG. 2 will provide a reference for discussion of the invention to follow. As can be seen in the example of FIG. 2, the LC panel 20 has a top side 30, a bottom side 32, a left side 34 and a right side 36. It should be noted that the sides designated by the references 30 through 36 are somewhat arbitrary, as they would depend, for example, upon whether the LC panels 20 are viewed from the front or from the back. For the purposes of this example it is assumed that these designations are assigned as the viewer looks into the front of the LC panel 20. It should also be noted that the example of FIG. 2 is intended to be applicable to all three of the LC panels 20, to be discussed in more detail hereinafter.

FIG. 3 is an exploded diagrammatic view of the combined image 16. As can be seen in the view of FIG. 3, the combined image 16 is produced by combining a red image 16a, a green image 16b, and a blue image 16c. In practice the three images 16a, 16b and 16c will be superimposed to create the combined image 16. However, to illustrated the necessary aspects of the invention to be described herein, the images 16a, 16b and 16c are separated in the view of FIG. 3. As can be seen in the view of FIG. 3, the top 30 and bottom 32 are reversed in all three images 16a, 16b and 16c as compared to the example of the LC panel 20 of FIG. 2. This is because the lens assembly 20 (FIG. 1) turns the images 16a, 16b and 16c upside down. Of course this is corrected in the three panel LC projection apparatus 10 by providing signals to the LC panels 20 which will produce “upside down” images, such that the projected combined image 16 will be right side up in relation to the viewer.

As can also be seen in the view of FIG. 3, the green image 16b also has the left side 34 and right side 36 thereof reversed, as compared to the origin as illustrated by the example of FIG. 2, while the red image 16a and the blue image 16b are oriented (left to right) as is the example of FIG. 2. In this particular example, this is because the green image 16b is projected directly onto the lens assembly 14, and is reversed left to right by the lens assembly 14. On the other hand, both the red image 16a and the blue image 16c are reversed left to right within the projector housing and the reversed again by the lens assembly 14 such that they are again oriented as they originated in the red LC panel 20a and the blue LC panel 20c (FIG. 1), respectively.

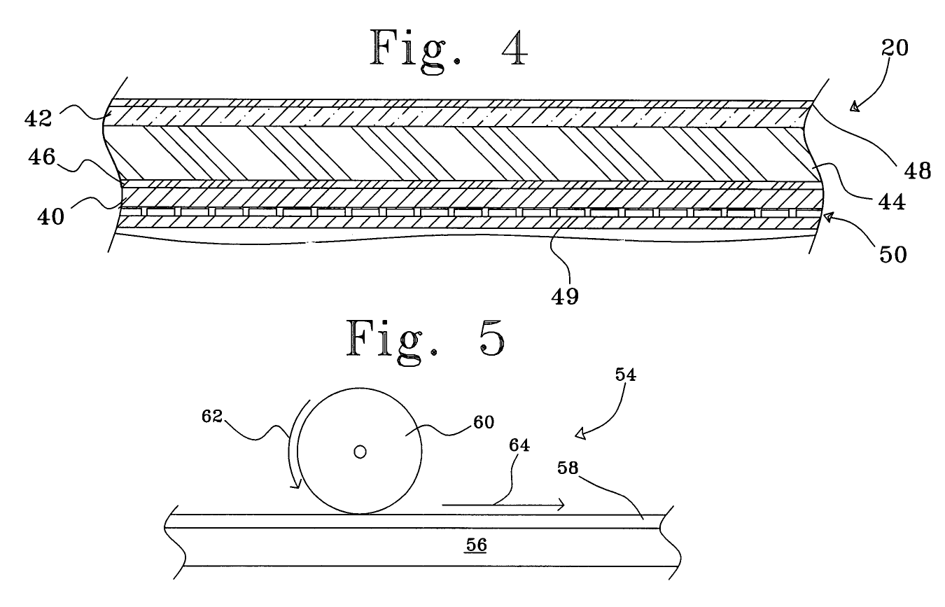

FIG. 4 is a partial cross sectional side elevational view of one of the LC panels 20 as used in the present invention. The example of FIG. 4 will apply to all three of the LC panels 20a, 20b, and 20c (FIG. 1). In the view of FIG. 4, it can be seen that the PC panels 20 have an upper silicon layer 40 and a glass layer 42. Liquid crystal 44 material is sandwiched between the upper silicon layer 40 and the glass layer 42. The upper silicon layer 40 has a thin silicon buff layer 46 thereon, and the glass layer 42 has a thin glass buff layer 48 thereon. One skilled in the art will be familiar with the buff layers 46 and 48. The buff layers 46 and 48 are made of a material, generally a polymer such as polyimide which can be buffed to create a buff direction, as will be discussed in more detail hereinafter. A mirror layer 49 having a plurality (equal to the number of “pixels” in the particular LC panel 20) of mirrors is provided under the upper silicon layer 40. The mirrors 40 both reflect light projected thereon (unless the light is blocked by the liquid crystal 44) and act as one electrode for potentially aligning the liquid crystal 44. Omitted from the view of FIG. 4 are additional circuitry layers below the mirrors 50, an upper conductive layer (such as indium tin oxide, or the like) which is provided as an electrode opposing the mirrors 50, electrical connections to the mirrors, and the like, all of which will be well known to one skilled in the art. It should be noted that the diagram of FIG. 4 and the description relating thereto could apply equally to the prior art or to the present inventive construction. However, some of the components of FIG. 4 differ from the prior art in aspects which will be discussed hereinafter.

FIG. 5 is a diagrammatic representation of a buffing apparatus 54. The example of FIG. 5 does not attempt to accurately depict the machinery used to accomplish the actions to be discussed. One skilled in the art will be thoroughly familiar with such apparatus. Rather the example of FIG. 5 is being introduced in order to illustrate some aspects of the invention which will be discussed in more detail hereinafter. Shown in the view of FIG. 5 is an underlying layer 56 which has been surfaced with an example of a buff layer 58. The example of FIG. 5 applies equally to operations wherein the underlying layer 56 is either the upper silicon layer 40 or the glass layer 42 (FIG. 4) and/or wherein the buff layer 58 is either the silicon buff layer 46 or the glass buff layer 48 (FIG. 4). In the example of FIG. 5 can also be seen a diagrammatic illustration of a buffing wheel 60. As the buffing wheel 60 rotates as indicated by a rotational arrow 62 the buff layer 58 is aligned as indicted by a buff direction arrow 64. One skilled in the art will recognize that there is not complete agreement in the art regarding the effects of the buffing operation. Whether the most important aspect is that the molecules of the buff layer 58 are stretched and/or aligned as indicated by the buff direction arrow 64, or whether minute scratches are created in the buff layer 58 that contribute to the desired effect, it is recognized in the art that the buffing operation creates an alignment along which molecules of the liquid crystal 44 (FIG. 4) will readily align, as will be discussed in more detail hereinafter.

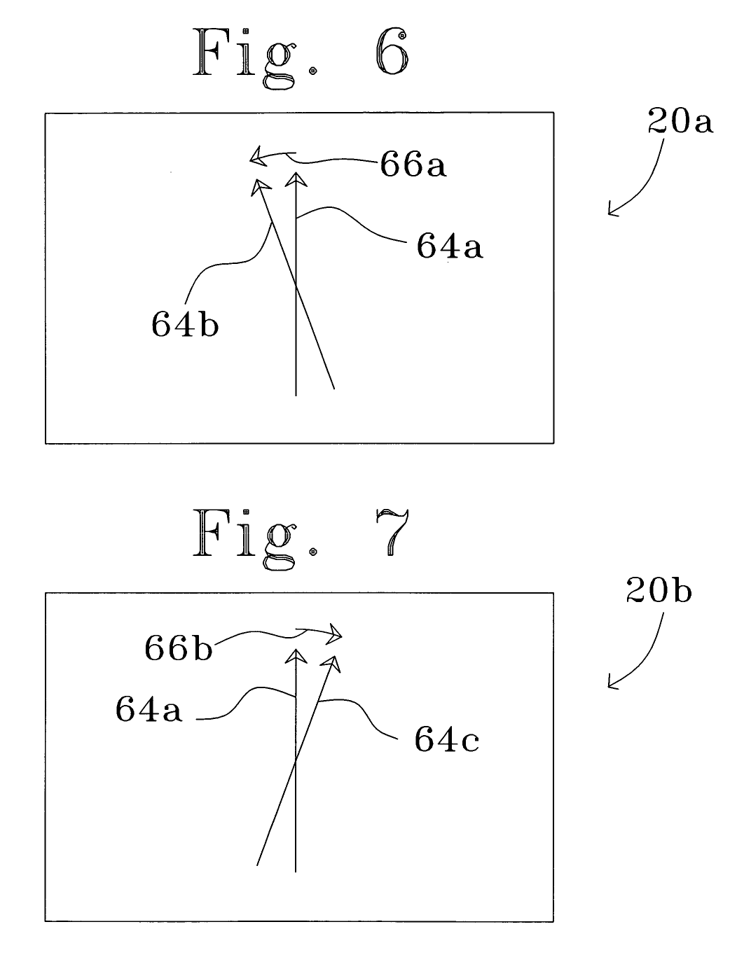

FIG. 6 is a diagrammatic representation depicting relative buff directions in a LC projection apparatus according to the present invention. In the example of FIG. 6, a first glass buff layer direction arrow 64a provides a reference direction such as might be used as a buff direction in any of the LC panels 20 (FIG. 1). Also in the example of FIG. 6 can be seen a silicon buff layer direction arrow 64b such as might be used as a buff direction in prior art LC panels (not shown), and also such as might be used in the red panel 20a and the blue panel 20c in the example of the present inventive three panel LC projection apparatus 10 (FIG. 1). FIG. 7 is a diagrammatic representation depicting relative buff directions in the example of the green panel 20b of the example of the present invention here described. As can be seen by comparing the examples of FIGS. 6 and 7, the glass buff layer direction arrow 64a in both figures indicates that the buff direction is the same in all three LC panels 20 (as indicted for the red and blue panels 20a and 20c in FIG. 6, and for the green panel 20b in FIG. 7). However, an alternate silicon buff layer direction arrow 64c indicates an alternate buff direction which is angularly offset in an opposing direction as compared to the silicon buff layer direction arrow 64b of FIG. 6. According to this example of the present invention, the silicon buff layer 46 (FIG. 4) of the green panel 20b (FIG. 1) will be buffed as indicated by the alternate silicon buff layer direction arrow 64c.

One skilled in the art will recognize that, since the molecules of the liquid crystal 44 (FIG. 4) will tend to seek the lowest energy alignment when power is applied to the individual mirror 50 (FIG. 4) thereunder, the rotation of the liquid crystal 44 in the green panel 20b will tend to be the mirror image of the rotation of the liquid crystal 44 in the red panel 20a and the blue panel 20c. One skilled in the art will be familiar with the degree of rotation of the silicon buff layer direction arrows 64b and 64c from the reference direction of the glass buff layer direction arrow 64a. In the present example, the silicon buff layer direction arrows 64b and 64c are rotated 45 degrees from the glass buff layer direction arrow 64a.

In order for the liquid crystal 44 to twist in the direction urged as described above, the formulation of the liquid crystal 44 in the green panel 20b should be altered as compared to that used in the red panel 20a and the blue panel 20c. The liquid crystal material is readily available from a number of sources. In the example here presented, the liquid crystal material is obtained from Merck® & Co., Inc. In this example the Merck® part designation for the formulation of the liquid crystal 44 in the red panel 20a and the blue panel 20c is 10400-061 +0.15% R811. The designation number for the formulation of the liquid crystal 44 in the green panel 20b is 10400-061 +0.15 S811. In the view of FIG. 6 a relative twist direction for the red panel 20a and the blue panel 20c of the presently described example is shown by a twist direction arrow 66a. In the view of FIG. 7 an opposing twist direction arrow 66b indicates the relative twist direction arrow in the green panel 20b of the presently described example of the invention.

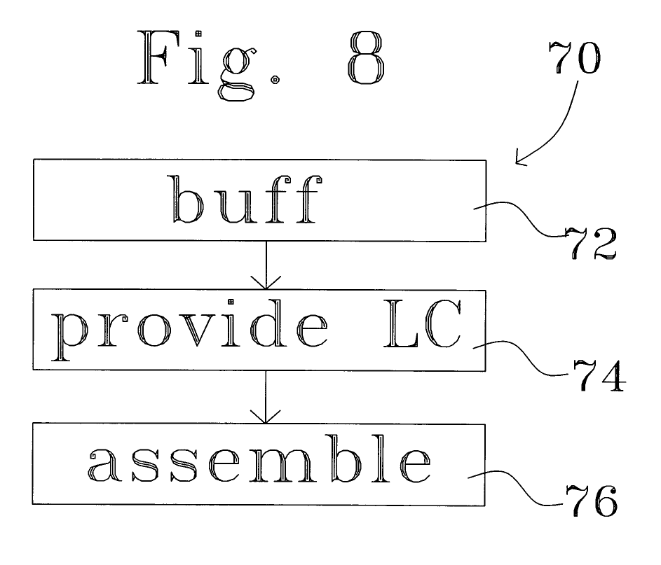

FIG. 8 is a flow diagram summarizing an example of a color shift correction method 70. According to the color shift correction method 70, in a buff operation 72, the LC panels 20 are buffed as described above, and one of the LC panels 20 is buffed as described above in relation to FIGS. 6 and 7 such that the buff pattern is the mirror image of the other two LC panels 20. One skilled in the art will recognize that the one LC panel 20 that is produced as the mirror image need not necessarily be the green panel 20b as shown in the previously described example. Rather, whichever of the LC panels 20 that is to be placed such that the image therefrom is reversed in relation to the other two should be so treated. In a provide liquid crystal operation 74, the LC panels 20 are provided with liquid crystal 44 as described previously herein. While the operations 72 and 74 distinguish the present invention over the prior art, in order to complete the assembly of the three panel LC projection apparatus 10, the three LC panels 20, produced according to the method and apparatus described herein, are affixed to the projector housing 12 (FIG. 1) in an assemble operation 76 in order to produce the inventive three panel LC projection apparatus 10.

According to the above description of the present invention, one skilled in the art will now recognize that when the images 16 from three LC panels 20 are superimposed through the projection system that the projected orientation of the buff direction 64 for all three LC panels 20 will be alike.

Although the invention has been described herein in relation to a three LC panel projection system, one skilled in the art will recognize that the invention could be applied to essentially any multi-panel projection system wherein an image from one or more of the panels is reversed as compared to the image from one or more of the other panels. Another obvious modification would be to leave the relative buff direction of the silicon buff layer direction 64b consistent in all three LC panels 20 while varying the buff direction of one of the glass buff layer directions 64a. One skilled in the art could readily modify the invention from that of the specific examples given such that it could be adapted to any such system now in existence, or yet to be developed in the future.

Further, LC panels typically do not include indicia of the buff direction and/or the twist direction LC material of the panel. However, in view of the foregoing disclosure, it should be understood that providing such indicia in association with LC panels will be particularly useful in the construction of projection systems, and is considered to be an inventive aspect of the present invention. An LC panel can include such indicia either directly on the panel itself, or on materials (packaging, literature, part numbers, etc.) associated with the particular LC panel.

All of the above are only some of the examples of available embodiments of the present invention. Those skilled in the art will readily observe that numerous other modifications and alterations may be made. Many of the described features may be substituted, altered or omitted without departing from the spirit and scope of the invention. For example, either the red panel 20a or the blue panel 20b could be the one which has a reversed image as compared to the remainder of the LC panels 20. These and other deviations from the particular embodiments shown will be apparent to those skilled in the art, particularly in view of the foregoing disclosure. Therefore, one skilled in the art could readily create variations of the invention to adapt it according to the needs or convenience of a particular application. Accordingly, the this disclosure is not intended as limiting and the appended claims are to be interpreted as encompassing the entire scope of the invention.

NOTICE: This correspondence chart is provided for informational purposes only. It is not a part of the official Patent Application.

### Correspondence Chart

three panel LC projection apparatus 10
projector housing 12
lens assembly 14
combined image 16
red image 16a
green image 16b
blue image 16c
projection screen 18
LC panels 20
red panel 20a
green panel 20b
blue panel 20c
top side 30
bottom side 32
left side 34
right side 36.
upper silicon layer 40
glass layer 42
liquid crystal 44
silicon buff layer 46
glass buff layer 48
mirror layer 49
mirrors 50
buffing apparatus 54
underlying layer 56
buff layer 58
buffing wheel 60
rotational arrow 62
buff direction arrow 64
glass buff layer direction arrow 64a
silicon buff layer direction arrow 64b
alternate silicon buff layer direction arrow 64c
color shift correction method 70
buff operation 72
provide liquid crystal operation 74
assemble operation 76

1. A video display apparatus, comprising:
a first display panel, a second display panel and a third display panel; wherein:
the first display panel has an aspect which is generally the mirror image of the similar aspect of the second display panel and the third display panel.

2. The video display apparatus of claim 1, wherein:
the aspect is the relative buff direction of a buff layer.

3. The video display apparatus of claim 2, wherein:
the buff layer is a silicon buff layer.

4. The video display apparatus of claim 2, wherein:
the buff layer is a glass buff layer.

5. The video display apparatus of claim 2, wherein:
the buff layer is a layer of material overlying a silicon layer.

6. The video display apparatus of claim 2, wherein:
the buff layer is a layer of material overlying a glass layer.

7. The video display apparatus of claim 2, wherein:
the buff layer is a polyimide layer overlying a silicon layer.

8. The video display apparatus of claim 2, wherein:
the buff layer is a polyimide layer overlying a glass layer.

9. The video display apparatus of claim 1, wherein:
the first display panel is a green display panel.

10. The video display apparatus of claim 1, wherein:
the video display apparatus is a three panel projection display apparatus.

11. The video display apparatus of claim 1, wherein:
each of the first display panel, the second display panel and the third display panel is a liquid crystal display.

12. The video display apparatus of claim 1, wherein:
each of the first display panel, the second display panel and the third display panel is a reflective liquid crystal display.

13. The video display apparatus of claim 1, wherein:
the video display apparatus is a non-telecentric projection system.

14. The video display apparatus of claim 1, wherein:
the aspect is the relative twist direction of a liquid crystal material layer.

15. A set of liquid crystal panels for a video projection system, comprising:
a first panel having a fist relative buff direction;
a second panel having the first relative buff direction; and
a third panel having a second relative buff direction.

16. The set of claim 15, wherein:
the second relative buff direction is generally a mirror image direction as compared to the first relative buff direction.

17. The set of claim 15, wherein:
the second relative buff direction is offset from a reference buff direction by an amount equal to but opposite an offset of the first relative buff direction.

18. A set of liquid crystal panels for a video projection system, comprising:
a first panel having a first relative liquid crystal twist direction;
a second panel having the first relative liquid crystal twist direction; and
a third panel having a second relative liquid crystal twist direction.

19. The set of claim 18, wherein:
the second relative liquid crystal twist direction is generally a mirror image direction as compared to the first relative liquid crystal twist direction.

20. The set of claim 18, wherein:
the second relative liquid crystal twist direction is offset from a reference liquid crystal twist direction by an amount equal to but opposite an offset of the first relative liquid crystal twist direction.

21. A method for producing a multi-panel display apparatus, comprising:
buffing a first panel buff layer in a first direction;
buffing a second panel buff layer in the first direction; and
buffing a third panel buff layer in a second direction.

22. The method of claim 21, wherein:
the first panel buff layer, the second panel buff layer, and the third panel buff layer are each buff layers overlaying a silicon layer in, respectively, a first panel, a second panel, and a third panel.

23. The method of claim 22, and further including:
providing a liquid crystal in the first panel having a first twist direction;
providing a liquid crystal in the second panel having the first twist direction; and
providing a liquid crystal in the third panel having a second twist direction.

24. The method of claim 22, and further including:
assembling the fist panel, the second pane, and the third panel such that a first image from the first panel, a second image from the second panel, and a third image from the third panel converge to create a combined image.

25. The method of claim 21, wherein:
the third panel buff layer is a layer in a green display panel.

26. A liquid crystal panel comprising:
a buff layer;
a liquid crystal layer; and
indicia of a buff direction associated with said buff layer.

27. A liquid crystal panel according to claim 26, further comprising indicia of a twist direction associated with said liquid crystal layer.

28. A liquid crystal panel according to claim 26, wherein said indicia of said buff direction is included in a part number associated with said panel.
